(19) United States
(12) Patent Application Publication
(10) Pub. No.: US 2025/0294285 A1
(43) Pub. Date: Sep. 18, 2025

(54) AUDIO SPEAKERS WITH NESTED COMPONENTS

(71) Applicant: Apple Inc., Cupertino, CA (US)

(72) Inventors: Reza GHAFFARIVARDAVAGH, San Jose, CA (US); Logan A. ROTOLO, Santa Monica, CA (US)

(21) Appl. No.: 18/757,410

(22) Filed: Jun. 27, 2024

Related U.S. Application Data
(63) Continuation-in-part of application No. 18/603,183, filed on Mar. 12, 2024, now abandoned.

(51) Int. Cl. H04R 1/24; H04R 1/32; H04R 7/18; H04R 9/02; H04R 9/04; H04R 9/06

(52) U.S. Cl. CPC H04R 1/24; H04R 1/323; H04R 7/18; H04R 9/025; H04R 9/045; H04R 9/06; H04R 2400/11; H04R 2499/15

(57) ABSTRACT

A speaker assembly includes multiple audio speakers in which an audio speaker is designed to receive, or at least partially receive, in an additional audio speaker. The audio speaker may include a magnet (e.g., permanent magnet) that includes an opening into which a voice coil of the additional audio speaker is positioned. The voice coil of the additional audio speaker is close enough in proximity to the magnet such that the voice coil may sense the magnetic field from the magnet may and magnetically attract to or repel the voice coil, based on a polarity of the voice coil when the voice coil forms an electromagnet. In this regard, the audio speakers may share the magnet, as one of the audio speaker does not require its own dedicated, permanent magnet.

### CROSS REFERENCE TO RELATED APPLICATION(S)

The present application is a continuation-in-part of U.S. patent application Ser. No. 18/603,183, entitled “AUDIO SPEAKERS WITH NESTED COMPONENTS,” filed Mar. 12, 2024, the contents of which are incorporated herein by reference in its entirety for all purposes.

### TECHNICAL FIELD

This application is directed to audio speakers, and more particularly, to multiple audio speakers with one audio speaker positioned within another audio speaker.

### BACKGROUND

Electronic devices may include multiple speakers, some of which are used to produce different sounds. For example, an electronic device may include a tweeter and a woofer.

### BRIEF DESCRIPTION OF THE DRAWINGS

Certain features of the subject technology are set forth in the appended claims. However, for purpose of explanation, several embodiments of the subject technology are set forth in the following figures.

FIG. 1 illustrates a perspective view of an example of an electronic device, in accordance with one or more aspects of the present disclosure.

FIG. 2 illustrates a perspective view of a speaker assembly, in accordance with one or more aspects of the present disclosure.

FIG. 3 illustrates an alternate perspective view of a speaker assembly, in accordance with one or more aspects of the present disclosure.

FIG. 4 illustrates an exploded view of a speaker assembly, in accordance with one or more aspects of the present disclosure.

FIG. 5 illustrates a cross sectional view of a speaker assembly, in accordance with one or more aspects of the present disclosure.

FIG. 6 illustrates an alternate cross sectional view of a speaker assembly, in accordance with one or more aspects of the present disclosure.

FIG. 7 illustrates a plan view of a magnet assembly, in accordance with one or more aspects of the present disclosure.

FIG. 8 illustrates a perspective view of an alternate example of a speaker assembly, showing an alternate location of a port, in accordance with one or more aspects of the present disclosure.

FIG. 9 illustrates a perspective view of an alternate example of a speaker assembly, showing an alternate location of a port, in accordance with one or more aspects of the present disclosure.

FIG. 10 illustrates a cross sectional view of an alternate example of a speaker assembly, showing a magnet with an offset cut, in accordance with one or more aspects of the present disclosure.

FIG. 11 illustrates a cross sectional view of an alternate example of a speaker assembly, showing an additional magnet for an audio speaker, in accordance with one or more aspects of the present disclosure.

FIG. 12 illustrates an electronic system with which one or more implementations of the subject technology may be implemented.

### DETAILED DESCRIPTION

The detailed description set forth below is intended as a description of various configurations of the subject technology and is not intended to represent the only configurations in which the subject technology may be practiced. The appended drawings are incorporated herein and constitute a part of the detailed description. The detailed description includes specific details for the purpose of providing a thorough understanding of the subject technology. However, it will be clear and apparent to those skilled in the art that the subject technology is not limited to the specific details set forth herein and may be practiced without these specific details. In some instances, well-known structures and components are shown in block diagram form in order to avoid obscuring the concepts of the subject technology.

The present disclosure is directed to speaker assemblies in which multiple speaker components are integrated together. Speaker assemblies described herein may include multiple audio speakers, such as a first audio speaker (e.g., tweeter) and a second audio speaker (e.g., woofer). One of the audio speakers (e.g., the second audio speaker) includes a space, or void, to receive, or at least partially receive, the other audio speaker (e.g., the first audio speaker) in the space. For example, the second audio speaker may include a permanent magnet with a portion removed to create an opening. The opening provides the space for the first audio speaker, and in particular, for a voice coil of the first audio speaker. Based on the relative position between the voice coil of the first audio speaker and the permanent magnet of the second audio speaker, the first audio speaker may not require its own dedicated, or exclusive, permanent magnet, as the voice coil of the first audio speaker is close enough in proximity to the magnetic field generated by the permanent magnet of the second audio speaker. As a result, the voice coil may sense the magnetic flux from the permanent magnet, and when receiving an alternating electrical current, the voice coil may form an electromagnet that is magnetically attracted to the permanent magnet in one direction of flow of the electrical current, and also magnetically repelled by the permanent magnet in another, opposing direction of flow of the electrical current. Accordingly, the voice coil, when forming an electromagnet, may include a predetermined polarity that is based on the flow of electrical current through the voice coil. Additionally, the opening of the permanent magnet may provide a back volume for the first audio speaker.

The speaker assembly may further include a frame into which the audio speakers are mounted. The frame may include a port that is split into two openings that provide a respective acoustical pathway for the audio speakers. Devices, such as a head-mounted display (e.g., HMD), implementing the speaker assembly (or assemblies) may not require additional space for the back volume of the audio speaker. Beneficially, speaker assemblies described herein may provide a smaller footprint that efficiently carries multiple audio speakers in a relatively small space, while also sharing some components (e.g., a magnet).

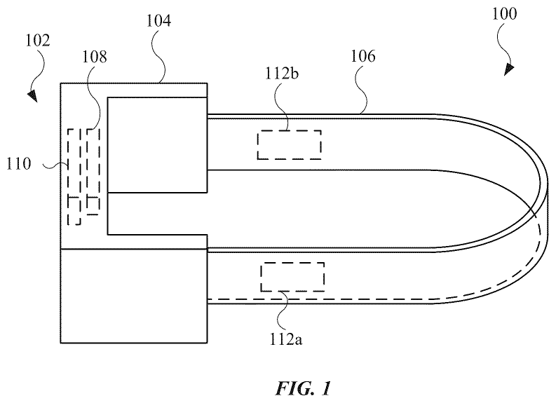

These and other embodiments are discussed below with reference to FIGS. 1-12. However, those skilled in the art will readily appreciate that the detailed description given herein with respect to these Figures is for explanatory purposes only and should not be construed as limiting.

FIG. 1 illustrates a perspective view of an example of an electronic device 100, in accordance with one or more aspects of the present disclosure. The electronic device 100 may include a head-mountable device 102, and accordingly, the electronic device 100 may take the form of an HMD. However, as non-limiting example, the electronic device 100 may take the form of other devices, such as smartphones, laptops, and tablet computing devices.

The head-mountable device 102 may include a frame 104 and a strap 106 designed to couple/secure to the frame 104. In one or more implementations, the frame 104 and the strap 106 may be decoupled from each other. The frame 104 may be positioned in front of the eyes of a user to provide information within a field of view of the user. The frame 104 may provide nose pads or another feature to rest on a user's nose. The frame 104 further includes one or more displays 108 (e.g., one for each eye). The head-mountable device 102 can include a camera 110, representative of one or more cameras, for capturing a view of an environment external to the head-mountable device 102. The one or more displays 108 can provide visual (e.g., image or video) output based on the view captured by the camera 110. For example, the one or more displays 108 can transmit light from the camera 110 based on a physical environment for viewing by the user. The one or more displays 108 can include components with optical properties, such as lenses for vision correction based on incoming light from the physical environment. Additionally or alternatively, the one or more displays 108 can provide information as a display within a field of view of the user. Displayed information can be provided to the exclusion of a view of a physical environment or in addition to (e.g., overlaid with) a physical environment.

The frame 104 and/or the strap 106 can serve to surround a peripheral region of the head-mountable device 102 as well as support any internal components in their assembled position. For example, the frame 104 can enclose and support various internal components (including for example integrated circuit chips, processors, sensors, input/output devices, memory devices, and other circuitry) to provide computing and functional operations for the head-mountable device 102.

The electronic device 100 may further include a speaker assembly 112a and a speaker assembly 112b. In one or more implementations, the speaker assemblies 112a and 112b generate acoustical energy (e.g. soundwaves, audible sound), including in conjunction with visual information being presented on the one or more displays 108. In this regard, when the electronic device 100 is mounted on a user, the strap 106 may wrap around the user's head such that the speaker assemblies 112a and 112b are in proximity to respective ears of the user. Accordingly, the user may hear the acoustical energy generated by the speaker assemblies 112a and 112b.

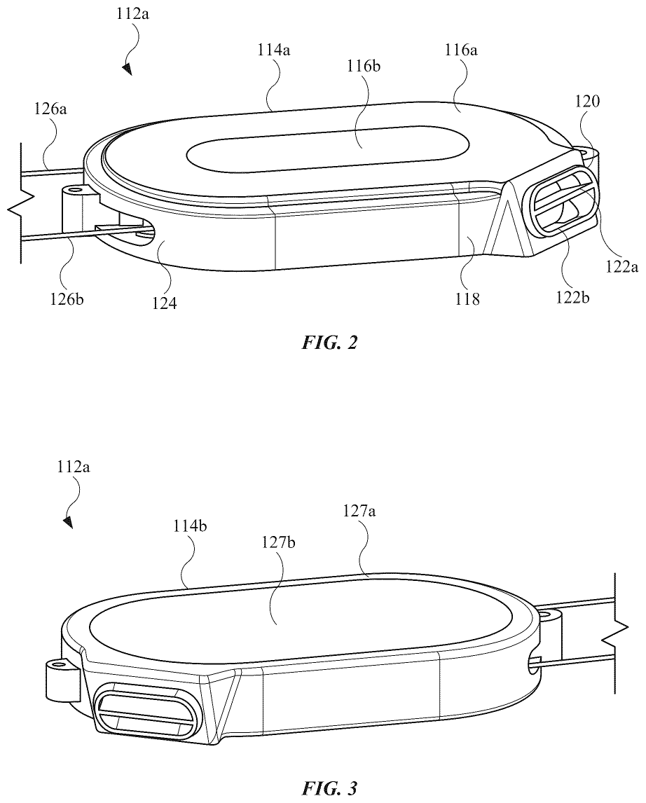

FIG. 2 illustrates a perspective view of the speaker assembly 112a, in accordance with one or more aspects of the present disclosure. The speaker assembly 112a may be representative of the speaker assembly 112b (shown in FIG. 1), and accordingly, the speaker assembly 112b may include any features shown and/or described herein for the speaker assembly 112a.

The speaker assembly 112a may include a cover 114a. The cover 114a may take the form of a multi-piece cover. For example, the cover 114a may include a portion 116a and a portion 116b surrounded by the portion 116a. As non-limiting examples, the portion 116a may include a non-metal (e.g., plastic) and the portion 116b may include a metal (e.g., steel).

The speaker assembly 112a may further include a frame 118 designed to couple with the cover 114a. The frame 118 may include various features, such as a port 120. The port 120 may include an opening 122a and an opening 122b, each of which may provide in part an acoustic pathway, or passage, through which acoustical energy from respective audio speakers (not shown in FIG. 2) may pass. In this regard, the speaker assembly 112a may include multiple audio speakers, with each audio speaker having a dedicated opening (e.g., the openings 122a and 122b) such that the port 120 provides respective acoustical pathways for the audio speakers.

The speaker assembly 112a may further include an opening 124 formed in the frame 118, with the opening 124 providing a pathway for wires into the speaker assembly 112a. For example, a wire 126a and a wire 126b may electrically couple with at least one of the aforementioned audio speakers. The wires 126a and 126b may provide control signals and/or electrical current in the form of an alternating electrical current.

FIG. 3 illustrates an alternate perspective view of the speaker assembly 112a, in accordance with one or more aspects of the present disclosure. The speaker assembly 112a may further include a cover 114b designed to couple with the frame 118. Similar to the cover 114a (shown in FIG. 2), the cover 114b may take the form of a multi-piece cover, and as a result, may include a portion 127a (e.g., plastic) and a portion 127b (e.g., steel) surrounded by the portion 127a.

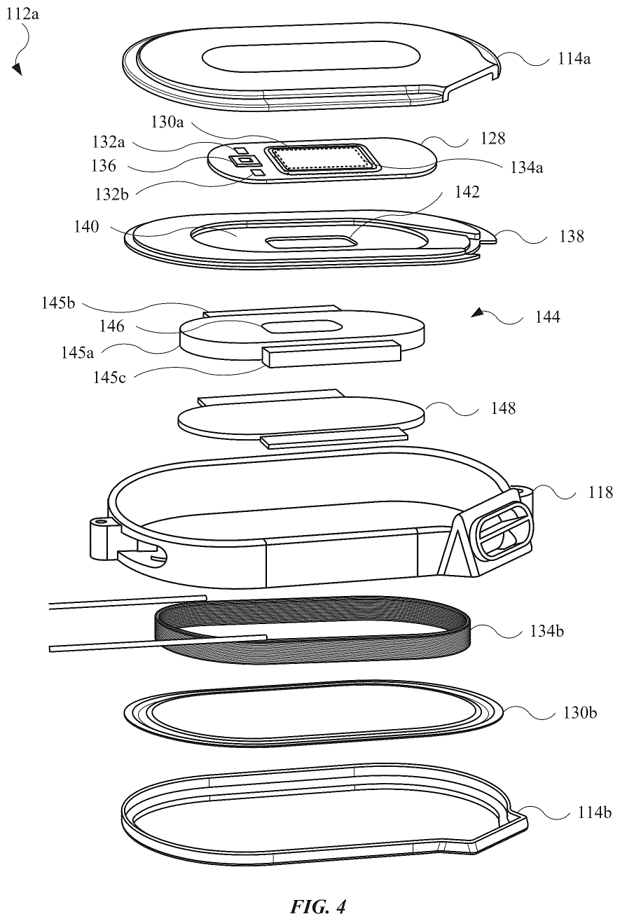

FIG. 4 illustrates an exploded view of the speaker assembly 112a, in accordance with one or more aspects of the present disclosure. When the speaker assembly 112a is assembled, the frame 118 and the covers 114a and 114b may combine to enclose the components of the speaker assembly 112a.

The speaker assembly 112a may include a frame 128 that carries various components. For example, the frame 128 may carry a diaphragm 130a, a pad 132a, a pad 132b, voice coil 134a, and a vent 136. The diaphragm 130a and the voice coil 134a may form in part an audio speaker designed to generate acoustical energy in accordance with a frequency range. In one or more implementations, the audio speaker may generate acoustical energy approximately in the range of 2,000 Hertz (Hz) to 20,000 Hz. In this regard, an audio speaker utilizing the diaphragm 130a and the voice coil 134a may function as a tweeter. The pads 132a and 132b may function as weld pads. In this regard, each of the pads 132a and 132b may function as a weld pad used to electrically and mechanically couple with one or more wires (not shown in FIG. 4). Accordingly, the pads 132a and 132b may each provide an electrical connection to receive control signals and/or electrical current in the form of an alternating electrical current. The voice coil 134a (shown as dotted lines) may be coupled with the diaphragm 130a and may receive electrical current via the pads 132a and 132b. The vent 136 may take the form of a barometric vent. The vent 136 may function to equalize pressure (e.g., air pressure) between air inside of the speaker assembly 112a and ambient air external to the speaker assembly 112a. Accordingly, the vent 136 may provide an air pathway into and out of the speaker assembly 112a.

The speaker assembly 112a may further include a yoke 138. The yoke 138 may include a recess 140, or indentation, having a size and shape to receive the frame 128. Additionally, the yoke 138 may include an opening 142. When the frame 128 is assembled with the yoke 138 at the recess 140, the voice coil 134a may pass through the opening 142 of the yoke 138. This will be shown below.

The speaker assembly 112a may further include a magnet assembly 144. The magnet assembly 144 may include one or more permanent magnets. As shown in FIG. 4, the magnet assembly 144 includes a magnet 145a, a magnet 145b, and a magnet 145c. As a non-limiting example, each of the magnets 145a, 145b, and 145c may include a rare Earth magnet (e.g., neodymium). The magnet assembly 144 may include an opening. As shown in FIG. 4, the opening 146 is formed in the magnet 145a. When the frame 128 and the magnet assembly 144 are assembled with the yoke 138 at opposing surfaces of the yoke 138, the voice coil 134a may also pass through the opening 146 of the magnet assembly 144. The speaker assembly 112a may further include a plate 148 on which the magnet assembly 144 lies. As a non-limiting example, the plate 148 may include a metal (e.g., steel).

The speaker assembly 112a may further include a voice coil 134b and a diaphragm 130b coupled with the voice coil 134b. The diaphragm 130b and the voice coil 134b may form in part an additional audio speaker designed to generate acoustical energy in accordance with a different frequency range. In one or more implementations, the additional audio speaker may generate acoustical energy approximately in the range of 20 Hz to 10,000 Hz. In this regard, an audio speaker utilizing the diaphragm 130b and the voice coil 134b may function as a woofer.

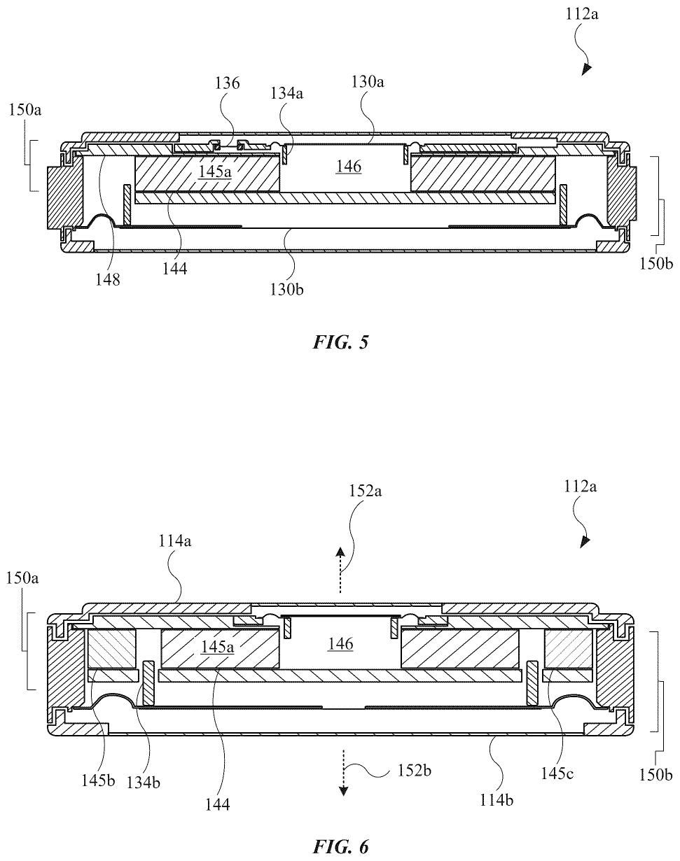

FIG. 5 illustrates a cross sectional view of the speaker assembly 112a, in accordance with one or more aspects of the present disclosure. As shown, the speaker assembly 112a may include an audio speaker 150a and an audio speaker 150b. The audio speaker 150a (e.g., tweeter) may include components such as the diaphragm 130a, the voice coil 134a, and the vent 136. Also, the audio speaker 150b (e.g., woofer) may include components such as the diaphragm 130b, the voice coil 134b, and the magnet assembly 144. When the speaker assembly 112a is assembled, the diaphragm 130a may be driven (e.g., acoustically driven) by the voice coil 134a, and the diaphragm 130b may be driven (e.g., acoustically driven) by the voice coil 134b. Based on the respective frequency ranges (discussed above), the audio speaker 150a is designed to provide acoustical energy in a frequency range that is greater than that of the audio speaker 150b.

Generally, each of audio speakers includes its own magnet assembly (e.g., permanent magnet(s)). However, based upon the relative position between the voice coil 134a of the audio speaker 150a and the magnet assembly 144, the audio speaker 150a may not require its own dedicated permanent magnet, as the voice coil 134a of the audio speaker 150a is close enough in proximity to the magnetic field generated by the magnet assembly 144. For example, the voice coil 134a is positioned, or at least partially positioned, in the opening 146 of the magnet 145a of the magnet assembly 144. The voice coil 134a may be in proximity to the magnet 145a such that a magnetic field from the magnet 145a extends to the voice coil 134a. As a result, the voice coil 134a may sense the magnetic flux from the magnet 145a, and when receiving an alternating electrical current, the voice coil 134a may form an electromagnet that is magnetically attracted to the magnet 145a in one direction of flow of the electrical current, and also magnetically repelled by the magnet 145b in another, opposing direction of flow of the electrical current.

Based on the arrangement in which the some components (e.g., voice coil 134a) of the audio speaker 150a are positioned in some components (e.g., the magnet 145a), the audio speakers 150a and 150b may share the at least some components, such as the magnet assembly 144, and in particular, the magnet 145a. Beneficially, not only is the overall footprint of the speaker assembly 112a reduced based on the shared components, but also the number of components required to assemble the speaker assembly 112a is reduced. This arrangement may provide additional benefits. For example, the opening 146 of the magnet 145a, along with the plate 148, may provide a back volume for the audio speaker 150a. Additionally, the space between the yoke 138 and the diaphragm 130b may provide a back volume for the audio speaker 150b.

FIG. 6 illustrates an alternate cross sectional view of the speaker assembly 112a, in accordance with one or more aspects of the present disclosure. As shown, the voice coil 134b of the audio speaker 150b is positioned between the magnets 145a and 145b, as well as between the magnets 145a and 145c. Also, the voice coil 134b, or at least a portion of the voice coil 134b, surrounds the magnet 145a. Also, the voice coil 134b, or at least a portion of the voice coil 134b, surrounds the opening 146. The voice coil 134b may be in proximity to the magnets 145a, 145b, and 145c, such that respective magnetic fields from the magnet 145a, 145b, and 145c extend to the voice coil 134a. As a result, the voice coil 134b may sense the magnetic flux from the magnets 145a, 145b, and 145c, and when receiving an alternating electrical current, the voice coil 134b may form an electromagnet that is magnetically attracted to the magnets 145a, 145b, and 145c in one direction of flow of the electrical current, and also magnetically repelled by the magnets 145a, 145b, and 145c in another, opposing direction of flow of the electrical current.

Additionally, based upon the respective positions of the audio speakers 150a and 150b, the acoustical energy generated by the audio speakers 150a and 150b may be directed in different directions. For example, the audio speaker 150a may generate acoustical energy in a direction designated by an arrow 152a and the audio speaker 150b may generate acoustical energy in a direction designated by an arrow 152b, with the direction of the arrows 152a and 152b being opposite, or at least approximately opposite, with respect to each other. However, the cover 114a and the cover 114b may direct the acoustic energy of the audio speaker 150a and the audio speaker 150b, respectively, in another direction, which may include through the opening 122a and the opening 122b, respectively, of the port 120 (shown in FIG. 2). Accordingly, the cover 114a and the cover 114b may each provide in part an acoustic pathway for the audio speaker 150a and the audio speaker 150b, respectively.

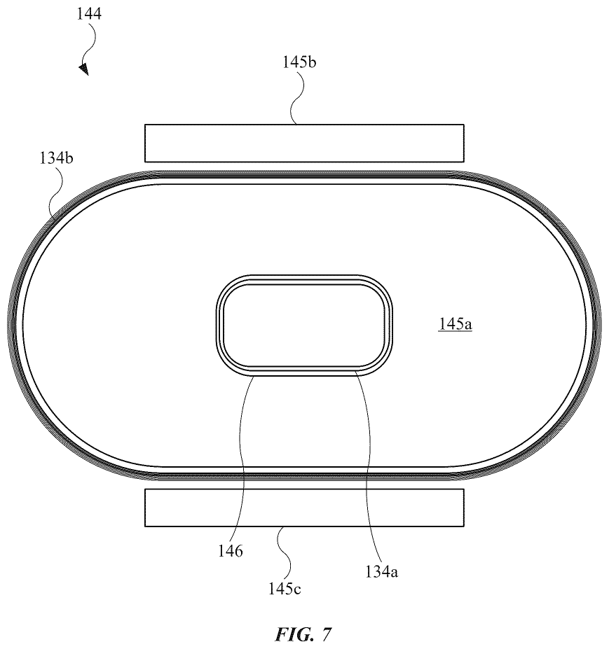

FIG. 7 illustrates a plan view of the magnet assembly 144, in accordance with one or more aspects of the present disclosure. Some of the magnets 145a, 145b, and 145c may include different shapes and/or sizes. For example, the magnet 145a includes an oblong shape, while the magnets 145b and 145c include a rectangular shape. Also, the size (e.g., surface area, volume) of the magnet 145a is larger than that of the magnet 145b, and also larger than that of the magnet 145c. However, the sizes and the shapes, and associated relationships, shown and/or described herein or the magnets 145a, 145b, and 145c should not be construed as limiting.

Also, the opening 146 of the magnet 145a is large enough to receive the voice coil 134a. However, the voice coil 134a may still sense the magnetic flux from the magnet 145a between on the position of the voice coil 134a relative to the magnet 145a. Further, the opening 146 is centered, or approximately centered, in the magnet 145a. Additionally, the magnet 145a is spaced apart from the magnets 145b and 145c such that the voice coil 134b may be positioned between the magnets 145a and 145b, as well as between the magnets 145a and 145c. However, the voice coil 134b may still sense the magnetic flux from the magnets 145a, 145b, and 145c.

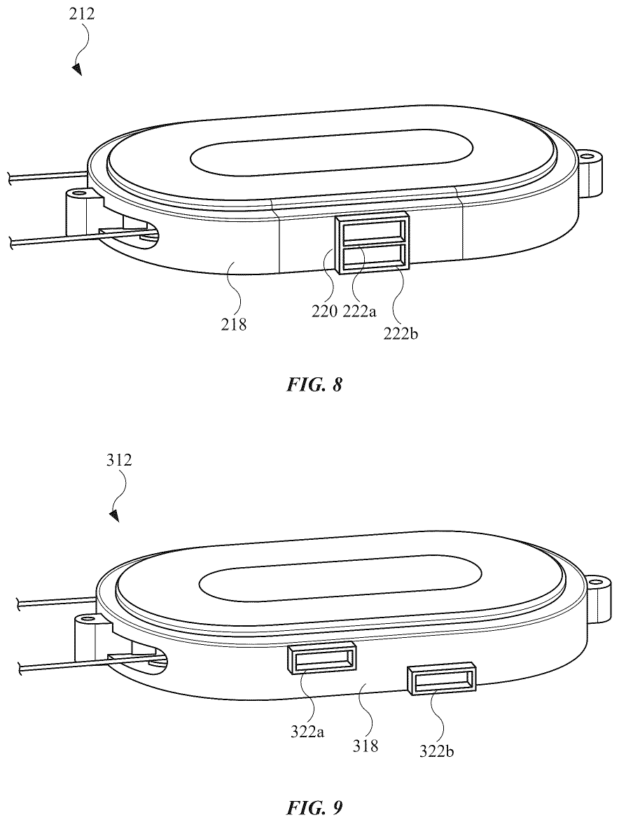

FIGS. 8-10 show and describe alternate examples of a speaker assembly suitable for use with electronic devices shown and/or described herein. Although not expressly shown and described, the respective speaker assemblies shown in FIGS. 8-10 may include several features previously shown and/or described for speaker assemblies (e.g., the speaker assembly 112a shown in FIG. 2). For examples, the respective speaker assemblies shown in FIGS. 8-10 may include multiple audio speakers.

FIG. 8 illustrates a perspective view of an alternate example of a speaker assembly 212, showing an alternate location of a port 220, in accordance with one or more aspects of the present disclosure. As shown, the speaker assembly 212 includes a frame 218 that provides in part an enclosure for the speaker assembly 212. The speaker assembly 212 may include a port 220 formed on a lengthwise wall of the frame 218. The port 220 may include an opening 222a for an audio speaker (e.g., tweeter) and an opening 222b for an additional audio speaker (e.g., woofer).

FIG. 9 illustrates a perspective view of an alternate example of a speaker assembly 312, showing an alternate location of a port, in accordance with one or more aspects of the present disclosure. As shown, the speaker assembly 312 includes a frame 218 that provides in part an enclosure for the speaker assembly 312. The speaker assembly 312 may include an opening 322a and an opening 322b, each of which are formed on a lengthwise wall of the frame 318. In this example, the openings 322a and 322b are separated, and shown in different locations of the frame 318. The openings 322a and 322b may collectively define a port for the speaker assembly 312. The opening 322a may define in part a passage for an audio speaker (e.g., tweeter) and the opening 322b may define in part a passage for an additional audio speaker (e.g., woofer).

FIGS. 8 and 9 illustrate a port, including openings, that is not limited to a particular location on a frame. Additionally, although not expressly shown, an opening, defining a passage for an audio speaker, may be formed in a cover (e.g., the cover 114a and/or the cover 114b, shown in FIG. 4) of a speaker assembly.

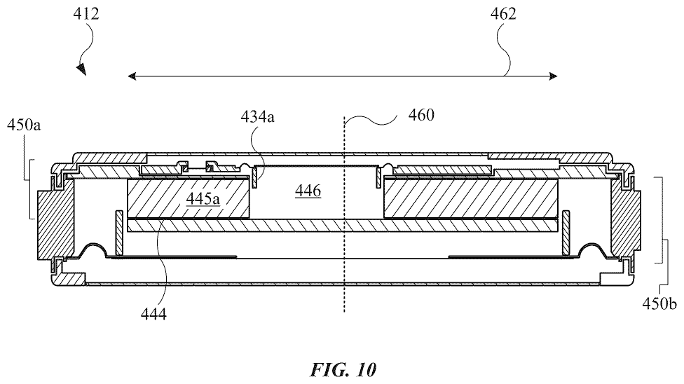

FIG. 10 illustrates a cross sectional view of an alternate example of a speaker assembly 412, showing a magnet 445a with an offset cut, in accordance with one or more aspects of the present disclosure. The speaker assembly 412 may include an audio speaker 450a and an audio speaker 450b. The speaker assembly 412 may further include a magnet assembly 444 that includes a magnet 445a, representative of additional magnets. The magnet 445a may include an opening 446, allowing a voice coil 434a to be positioned, or at least partially positioned, in the opening 446. As a result, the audio speakers 450a and 450b may share the magnet assembly 444, and in particular, the magnet 445a. An imaginary line 460 passes through a center of the magnet 445a is shown, illustrating the opening 446 is offset, or non-centered, in the magnet 445a. As a result, the audio speaker 450a may be offset within the speaker assembly 412 in order to fit the voice coil 434a within the opening 446. In one or more implementations, the opening 446 is offset by 20% of the width of the magnet 445a. For example, given the magnet 445a includes a dimension 462 (e.g., width), the center of the opening 446 may be offset from the imaginary line 460 (e.g., center line) by 20% of the magnitude of the dimension 462. The offset of 20% is intended to be exemplary, and the offset may be approximately in the range of 1% to 50%.

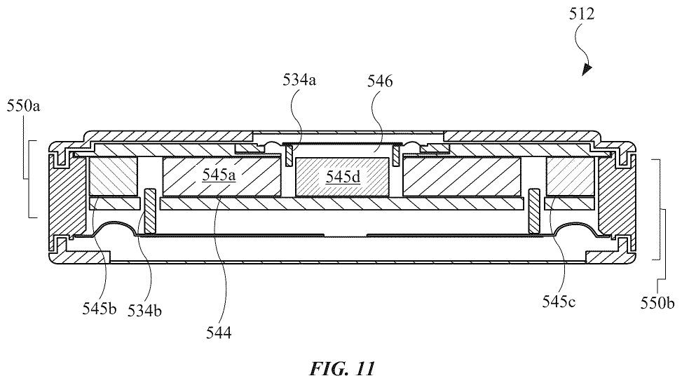

FIG. 11 illustrates a cross sectional view of an alternate example of a speaker assembly 512, showing an additional magnet for an audio speaker, in accordance with one or more aspects of the present disclosure. The speaker assembly 512 may include an audio speaker 550a and an audio speaker 550b. The audio speaker 550a and the audio speaker 550b may include a voice coil 534a and a voice coil 534b, respectively. The speaker assembly 512 may further include a magnet assembly 544, with the magnet assembly 544 including a magnet 545a, a magnet 545b, a magnet 545c, and a magnet 545d. As shown, the magnet 545a includes an opening 546, and the magnet 545d is positioned in the opening. Based on its position, the magnet 545d may function as a permanent magnet for the voice coil 534a, as the voice coil 534a may sense the magnetic flux from the magnet 545d. However, the voice coil 534a, in addition to the voice coil 534b, may sense the magnetic flux from the magnet 545a.

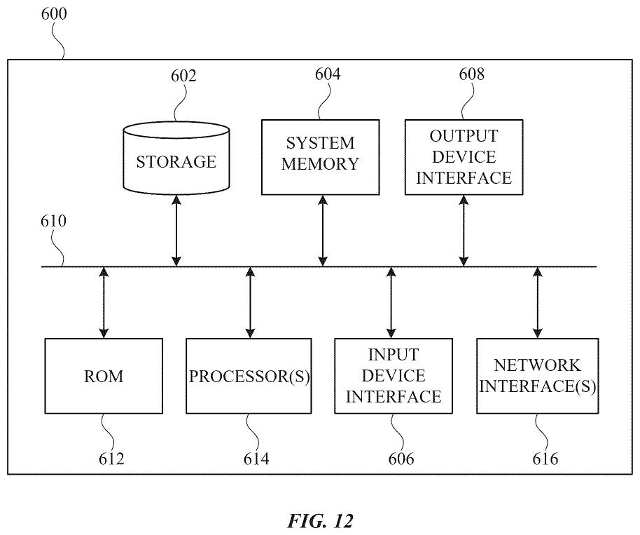

FIG. 12 illustrates an electronic system 600 with which one or more implementations of the subject technology may be implemented. The electronic system 600 can be, and/or can be a part of, the electronic device 100 as shown in FIG. 1. The electronic system 600 may include various types of computer readable media and interfaces for various other types of computer readable media. The electronic system 600 includes a bus 610, one or more processing units 614, a system memory 604 (and/or buffer), a ROM 612, a permanent storage device 602, an input device interface 606, an output device interface 608, and one or more network interfaces 616, or subsets and variations thereof. One or more of the components shown and described herein for the electronic system 600 may be optional.

The bus 610 collectively represents all system, peripheral, and chipset buses that communicatively connect the numerous internal devices of the electronic system 600. In one or more implementations, the bus 610 communicatively connects the one or more processing units 614 with the ROM 612, the system memory 604, and the permanent storage device 602. From these various memory units, the one or more processing units 614 retrieves instructions to execute and data to process in order to execute the processes of the subject disclosure. The one or more processing units 614 can be a single processor or a multi-core processor in different implementations.

The ROM 612 stores static data and instructions that are needed by the one or more processing units 614 and other modules of the electronic system 600. The permanent storage device 602, on the other hand, may be a read-and-write memory device. The permanent storage device 602 may be a non-volatile memory unit that stores instructions and data even when the electronic system 600 is off. In one or more implementations, a mass-storage device (such as a magnetic or optical disk and its corresponding disk drive) may be used as the permanent storage device 602.

In one or more implementations, an optional removable storage device (such as a flash drive, and its corresponding disk drive) may be used as the permanent storage device 602. Like the permanent storage device 602, the system memory 604 may be a read-and-write memory device. However, unlike the permanent storage device 602, the system memory 604 may be a volatile read-and-write memory, such as random access memory. The system memory 604 may store any of the instructions and data that one or more processing units 614 may need at runtime. In one or more implementations, the processes of the subject disclosure are stored in the system memory 604, the permanent storage device 602, and/or the ROM 612 (which are each implemented as a non-transitory computer-readable medium). From these various memory units, the one or more processing units 614 retrieves instructions to execute and data to process in order to execute the processes of one or more implementations.

The bus 610 also connects to the input device interface 606 and the output device interface 608. The input device interface 606 enables a user to communicate information and select commands to the electronic system 600. Input devices that may be used with the input device interface 606 may include, for example, alphanumeric keyboards and pointing devices (also called “cursor control devices”). The input device interface 606 may enable, for example, the display of images generated by electronic system 600. Exemplary output devices that may be optionally used with the input device interface 606 may include, for example, printers and display devices, such as a liquid crystal display (LCD), a light emitting diode (LED) display, an organic light emitting diode (OLED) display, a flexible display, a flat panel display, a solid state display, a projector, or any other device for outputting information. One or more implementations may include devices that function as both input and output devices, such as a touchscreen. In these implementations, feedback provided to the user can be any form of sensory feedback, such as visual feedback, auditory feedback, or tactile feedback; and input from the user can be received in any form, including acoustic, speech, or tactile input.

Finally, the bus 610 may also couple the electronic system 600 to one or more networks and/or to one or more network nodes, or through the one or more network interfaces 616. In this manner, the electronic system 600 can be a part of a network of computers (such as a LAN, a wide area network (“WAN”), or an Intranet, or a network of networks, such as the Internet. Any or all components of the electronic system 600 can be used in conjunction with the subject disclosure.

These functions described above can be implemented in computer software, firmware or hardware. The techniques can be implemented using one or more computer program products. Programmable processors and computers can be included in or packaged as mobile devices. The processes and logic flows can be performed by one or more programmable processors and by one or more programmable logic circuitry. General and special purpose computing devices and storage devices can be interconnected through communication networks.

Various examples of aspects of the disclosure are described below as clauses for convenience. These are provided as examples, and do not limit the subject technology.

In one or more aspects of the present disclosure, a speaker assembly is described. The speaker assembly may include a first audio speaker comprising a first voice coil. The speaker assembly may further include a second audio speaker. The second audio speaker may include a first magnet comprising an opening. The second audio speaker may further include a second voice coil that surrounds the opening. In one or more implementations, the first voice coil is at least partially positioned in the opening of the first magnet.

In one or more aspects of the present disclosure, a speaker assembly is described. The speaker assembly may include a first audio speaker configured to generate first sound in a first direction and in accordance with a first frequency range. The speaker assembly may further include a second audio speaker configured to generate second sound in a second direction different from the first direction and in accordance with a second frequency range different from the first frequency range. In one or more implementations, the first audio speaker is at least partially positioned in the second audio speaker.

In one or more aspects of the present disclosure, an electronic device is described. The electronic device may include a speaker assembly. The speaker assembly may include a first audio speaker. The speaker assembly may further include a second audio speaker. In one or more implementations, the first audio speaker is at least partially disposed in the second audio speaker. The speaker assembly may further include a magnet shared by the first audio speaker and the second audio speaker.

As used herein, the phrase “at least one of” preceding a series of items, with the term “and” or “or” to separate any of the items, modifies the list as a whole, rather than each member of the list (i.e., each item). The phrase “at least one of” does not require selection of at least one of each item listed; rather, the phrase allows a meaning that includes at least one of any one of the items, and/or at least one of any combination of the items, and/or at least one of each of the items. By way of example, the phrases “at least one of A, B, and C” or “at least one of A, B, or C” each refer to only A, only B, or only C; any combination of A, B, and C; and/or at least one of each of A, B, and C.

The predicate words “configured to”, “operable to”, and “programmed to” do not imply any particular tangible or intangible modification of a subject, but, rather, are intended to be used interchangeably. In one or more implementations, a processor configured to monitor and control an operation or a component may also mean the processor being programmed to monitor and control the operation or the processor being operable to monitor and control the operation. Likewise, a processor configured to execute code can be construed as a processor programmed to execute code or operable to execute code.

When an element is referred to herein as being “connected” or “coupled” to another element, it is to be understood that the elements can be directly connected to the other element, or have intervening elements present between the elements. In contrast, when an element is referred to as being “directly connected” or “directly coupled” to another element, it should be understood that no intervening elements are present in the “direct” connection between the elements. However, the existence of a direct connection does not exclude other connections, in which intervening elements may be present.

Phrases such as an aspect, the aspect, another aspect, some aspects, one or more aspects, an implementation, the implementation, another implementation, some implementations, one or more implementations, an embodiment, the embodiment, another embodiment, some embodiments, one or more embodiments, a configuration, the configuration, another configuration, some configurations, one or more configurations, the subject technology, the disclosure, the present disclosure, other variations thereof and alike are for convenience and do not imply that a disclosure relating to such phrase(s) is essential to the subject technology or that such disclosure applies to all configurations of the subject technology. A disclosure relating to such phrase(s) may apply to all configurations, or one or more configurations. A disclosure relating to such phrase(s) may provide one or more examples. A phrase such as an aspect or some aspects may refer to one or more aspects and vice versa, and this applies similarly to other foregoing phrases.

The word “exemplary” is used herein to mean “serving as an example, instance, or illustration”. Any embodiment described herein as “exemplary” or as an “example” is not necessarily to be construed as preferred or advantageous over other embodiments. Furthermore, to the extent that the term “include”, “have”, or the like is used in the description or the claims, such term is intended to be inclusive in a manner similar to the term “comprise” as “comprise” is interpreted when employed as a transitional word in a claim.

All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims. No claim element is to be construed under the provisions of 35 U.S.C. § 112, sixth paragraph, unless the element is expressly recited using the phrase “means for” or, in the case of a method claim, the element is recited using the phrase “step for”.

The previous description is provided to enable any person skilled in the art to practice the various aspects described herein. Various modifications to these aspects will be readily apparent to those skilled in the art, and the generic principles defined herein may be applied to other aspects. Thus, the claims are not intended to be limited to the aspects shown herein, but are to be accorded the full scope consistent with the language claims, wherein reference to an element in the singular is not intended to mean “one and only one” unless specifically so stated, but rather “one or more”. Unless specifically stated otherwise, the term “some” refers to one or more. Pronouns in the masculine (e.g., his) include the feminine and neuter gender (e.g., her and its) and vice versa. Headings and subheadings, if any, are used for convenience only and do not limit the subject disclosure.

What is claimed is:

1. A speaker assembly, comprising:
a first audio speaker comprising a first voice coil; and
a second audio speaker comprising:
a first magnet comprising an opening, and
a second voice coil that surrounds the opening,
wherein the first voice coil is at least partially positioned in the opening of the first magnet.

2. The speaker assembly of claim 1, further comprising:
a second magnet; and
a third magnet, wherein the second voice coil comprises:
a first portion at least partially positioned between the first magnet and the second magnet, and
a second portion at least partially positioned between the first magnet and the third magnet.

3. The speaker assembly of claim 2, further comprising a yoke that caries the first magnet, the second magnet, and the third magnet, wherein the first magnet and the yoke define in part a back volume for the first audio speaker.

4. The speaker assembly of claim 1, further comprising:
a first frame; and
a first diaphragm coupled with the first frame, the first diaphragm configured to be acoustically driven by the first voice coil.

5. The speaker assembly of claim 4, further comprising:
a plate coupled with the first frame;
a second frame that surrounds the first audio speaker and the second audio speaker; and
a second diaphragm, wherein the first magnet is positioned between the first diaphragm and the second diaphragm.

6. The speaker assembly of claim 5, wherein the second frame comprises a port, the port comprising:
a first opening defines in part a first acoustic pathway for the first audio speaker; and
a second opening defines in part a second acoustic pathway for the second audio speaker.

7. The speaker assembly of claim 4, further comprising a weld pad carried by the first frame, the weld pad providing an electrical connection to the first voice coil.

8. The speaker assembly of claim 1, further comprising:
a first cover that overlays the first audio speaker; and
a second cover that overlays the second audio speaker.

9. A speaker assembly, comprising:
a first audio speaker configured to generate first sound in a first direction and in accordance with a first frequency range; and
a second audio speaker configured to generate second sound in a second direction different from the first direction and in accordance with a second frequency range different from the first frequency range, wherein the first audio speaker is at least partially positioned in the second audio speaker.

10. The speaker assembly of claim 9, further comprising:
a magnet comprising an opening;
a first voice coil at least partially positioned in the opening; and
a second voice coil that surrounds the magnet.

11. The speaker assembly of claim 10, wherein the magnet generates a magnetic field that extends to the first voice coil and to the second voice coil.

12. The speaker assembly of claim 10, further comprising a yoke that caries the magnet, wherein the opening of the magnet and the yoke define in part a back volume for the first audio speaker.

13. The speaker assembly of claim 9, further comprising:
a frame comprising an opening; and
a plate coupled with the frame, wherein the first audio speaker comprises:
a diaphragm; and
a voice coil coupled with the diaphragm, wherein the voice coil is positioned in the opening.

14. The speaker assembly of claim 13, further comprising:
a vent carried by the frame, the vent configured to equalize pressure within the first audio speaker; and
a weld pad carried by the frame, the weld pad providing an electrical connection to the voice coil.

15. The speaker assembly of claim 9, further comprising a frame that surrounds the first audio speaker and the second audio speaker, the frame comprising:
a port that provides respective acoustical pathways for the first audio speaker and the second audio speaker; and
an opening separate from the port, the opening providing a pathway for wires for a voice coil of the second audio speaker.

16. The speaker assembly of claim 9, wherein the first frequency range is greater than the second frequency range.

17. An electronic device, comprising:
a speaker assembly, comprising:
a first audio speaker;
a second audio speaker, wherein the first audio speaker is at least partially disposed in the second audio speaker; and
a magnet shared by the first audio speaker and the second audio speaker.

18. The electronic device of claim 17, wherein:
the magnet comprises an opening, and
the first audio speaker comprises a voice coil at least partially positioned in the opening.

19. The electronic device of claim 17, further comprising a frame that surrounds the first audio speaker, the second audio speaker, and the magnet, wherein the frame comprises a port, the port comprising:
a first opening defines in part a first acoustic pathway for the first audio speaker; and
a second opening defines in part a second acoustic pathway for the second audio speaker.

20. The electronic device of claim 17, further comprising:
a head-mounted display; and
a strap coupled with the head-mounted display, wherein the speaker assembly is carried by the strap.
